(19) United States
(12) Patent Application Publication
(10) Pub. No.: US 2006/0055763 A1
(43) Pub. Date: Mar. 16, 2006

(54) Image processing apparatus

(75) Inventor: Junichi Matsunoshita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/081,512

(22) Filed: Mar. 17, 2005

(30) Foreign Application Priority Data
Sep. 16, 2004 (JP) P2004-270580

(51) Int. Cl. B41J 2/01

(52) U.S. Cl. 347/107

(57) ABSTRACT

The present invention provides an image processing apparatus which utilizes a first-type color material and a second-type color material which differ in reflection response to light falling within a predetermined wavelength range; which generates a code image from the first-type color material in accordance with data to be coded; which generates a modulated image from the second color material; and which combines the code image and the modulated image to generate a combined image. The combined image is recognized as different image from the code image under a light falling outside of the predetermined wavelength range.

### BACKGROUND OF THE INVENTION

1. Field of the Invention

The present invention relates to an image processing apparatus which generates a code image.

2. Description of the Related Art

In recent years, a barcode or the like has come into wide use as a technique for representing digital data which can be read by a computer on an image formed by a printer or a multifunction machine. In addition, a so-called “two-dimensional barcode” in which a barcode is rendered two-dimensional has also recently been into wide use in the field of; e.g., information provision to a cellular phone. Incidentally, it is known to provide a technique which enables detection of a code image through observation under a specific light source.

The above-mentioned barcode, two-dimensional barcode, or the like (hereinafter referred to as a “code image” in a sense of an image representing code data) represents a code making use of an image which can be optically read by means of, for instance, arranging two types of line segments which differ in width. Therefore, even a photocopied code image maintains its function as the code image.

Accordingly, the conventional code image is easily photocopied, thereby posing difficulty in taking countermeasures against unauthorized reproduction and the like. Against such a background, there has been required a technique which inhibits or prevents disclosure of a code expressed in the form of a code image.

### SUMMARY OF THE INVENTION

The present invention has been made in view of the above circumstances and aims at providing an image processing apparatus which can inhibit or prevent disclosure of a code represented in a form of a code image.

According to an aspect of the present invention, the present invention provides an image processing apparatus which utilizes a first-type color material and a second-type color material which differ in reflection response to light falling within a predetermined wavelength range, the image processing apparatus including: a controller that: generates a code image in accordance with data to be coded with use of the first-type color material; generates a modulated image with use of the second color material; and combines the code image and the modulated image to generate a combined image, wherein the combined image is recognized as different image from the code image under a light falling outside of the predetermined wavelength range.

According to another aspect of the present invention, the present invention provides an image processing apparatus which utilizes a first-type color material and a second-type color material which differ in reflection response to light falling within a predetermined wavelength range, the image processing apparatus including: a controller that: divides data to be encoded into a first portion and a second portion; generates a first code image in accordance with the first portion of the data to be coded from the first-type color material; generates a second code image in accordance with the second portion of the data to be coded from the second-type color material; and generates image data including the first code image and the second code image.

According to another aspect of the present invention, the present invention provides a decoder for reading a code image formed on a recording medium, the recording medium including: a code image generated in accordance with data to be coded with use of a first-type color material, and a modulated image generated with use of a second color material, wherein the first-type color material and the second-type color material differ in reflection response to light falling within a predetermined wavelength range, and the code image is processed to be ascertained as an image differing from the code image, under a light falling outside of the predetermined wavelength range, by combining the modulated image, the decoder including: a reading unit which reads the image formed on the recording medium under light falling within the predetermined wavelength range; a generating unit which generates image data in accordance with the read image; and a decoder that decodes the generated image in a predetermined decoding process. According to another aspect of the present invention, the present invention provides a decoder for reading a code image formed on a recording medium according, the recording medium including: a first code image generated from a first-type color material in accordance with a predetermined portion of data to be coded; and a second code image generated from a second-type color material in accordance with a portion other than the predetermined portion of the data to be coded, wherein the first-type color material and the second-type color material differ in reflection response to light falling within a predetermined wavelength range, the decoder including: a reading unit which reads the image formed on the recording medium under light falling within the predetermined wavelength range, and an image formed on the recording under light falling outside the predetermined wavelength range; and a generating unit which generates two sets of image data in accordance with the respective images obtained by reading; and a decoder that decodes the generated two set of image in a predetermined decoding process.

According to another aspect of the present invention, the present invention provides an image processing method which utilizes a first-type color material and a second-type color material which differ in reflection response to light falling within a predetermined wavelength range, the image processing method including: generating a code image from the first-type color material in accordance with data to be coded; generating a modulated image from the second color material; combining the code image and the modulated image to generate a combined image, wherein the combined image is recognized as different image from the code image under a light falling outside of the predetermined wavelength range.

### BRIEF DESCRIPTION OF THE DRAWING

An embodiment of the present invention will be described in detail based on the following figures, wherein:

FIG. 1 is a configuration block diagram of an image processing apparatus according to an embodiment of the present invention;

FIG. 2 is a block diagram showing an example configuration of the image processing apparatus according to the embodiment of the present invention;

FIGS. 3A and 3B are explanatory views each showing an example of a composite image;

FIGS. 4A to 4D are explanatory views showing scanned examples of the composite image;

FIGS. 5A to 5D are explanatory views showing other examples of the composite image;

FIGS. 6A to 6D are explanatory views showing further examples of the composite image; and

FIG. 7 is an explanatory view showing still another example of the composite image.

### DETAILED DESCRIPTION OF THE INVENTION

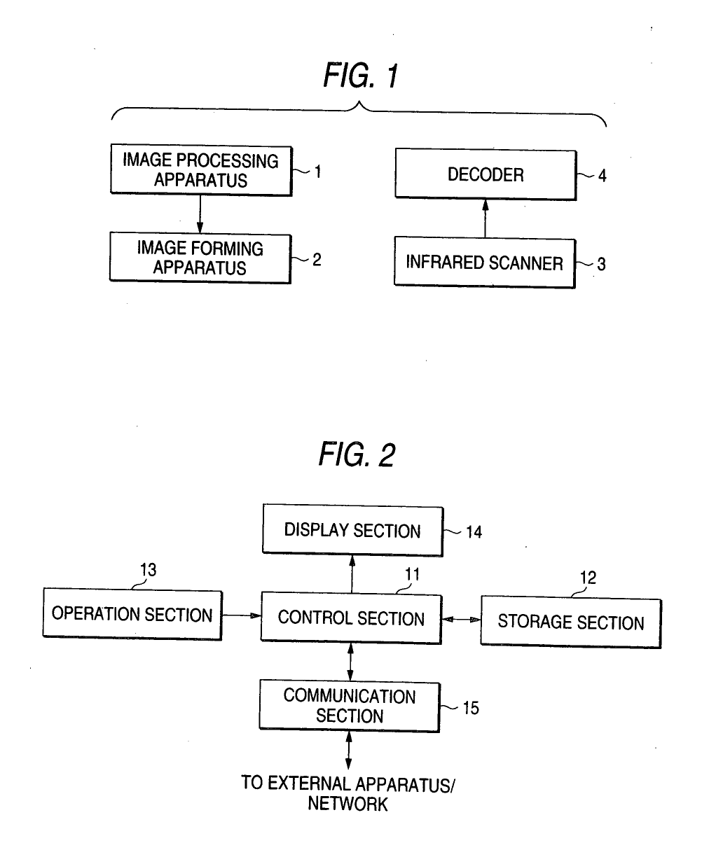

An embodiment of the invention will be described by reference to the drawings. An image processing system is configured to include, as shown in FIG. 1, an image processing apparatus 1, an image forming apparatus 2, an infrared scanner 3, and a decoder 4. As shown in FIG. 2, the image processing apparatus 1 is configured to include a control section 11, a storage section 12, an operation section 13, a display section 14, and a communication section 15. The image processing apparatus 1 is connected to the image forming apparatus 2. The decoder 4 includes, in a manner similar to the image processing apparatus 1 shown in FIG. 2, a control section 31, a storage section 32, an operation section 33, a display section 34, and a communication section 35 (for the sake of explanation, these are indicated by reference numerals different from those used in connection with the image processing apparatus). The decoder 4 is connected to the infrared scanner 3.

The control section 11 of the image processing apparatus 1 can be implemented by use of a CPU, or the like. The control section 11 operates in accordance with a program stored in the storage section 12. Operations performed by the control section 11 will be specifically described later.

The storage section 12 is a computer-readable storage medium, such as a storage element; for instance, a RAM (random access memory), a hard disk device, or the like. The storage section 12 stores programs to be executed by the control section 11. The storage section 12 also serves as a working memory for the control section 11.

The operation section 13 is a mouse or a keyboard. Upon receipt of an operation command from a user, the operation section 13 outputs corresponding contents to the control section 11. The display section 14, which is a display, or the like, displays data in accordance with a corresponding command input from the control section 11.

The communication section 15, which is a network interface, transmits data to a destination having been designated in accordance with the command input from the control section 11, by way of a network. The communication section 15 also receives data by way of the network, and outputs the data to the control section 11.

The image forming apparatus 2 is a color printer, or the like. The image forming apparatus 2 of the embodiment reproduces colors by use of four color toners of cyan (C), magenta (M), yellow (Y), and black (K). In addition, since cyan, magenta, and yellow of the toners reflect infrared light, the three colors appear bright (white) under infrared light. Meanwhile, since a monochrome black absorbs infrared light, the black appears dark (black) under infrared light. More specifically, when an image formed by the image forming apparatus 2 is read under infrared light, a portion of the image formed from the cyan, magenta and/or yellow toners becomes difficult to read; and a portion formed from the black toner becomes easy to read.

In other words, the toners of cyan, magenta and yellow, and that of black have different reflection responses to light falling within a specific wavelength range, such as infrared light; and one of these corresponds to a first-type color material, and the other one corresponds to a second-type color material.

By use of the toners, the present embodiment, the control section 11 generates a command for forming a code image from the first-type color material in accordance with data to be coded. In addition, the control section 11 generates a modulated image from the second-type color material, to thus generate image data which include the code image and the modulated image.

A code image according to an example of the embodiment is a plurality of sets of graphical elements formed from the first-type color material. In the embodiment, the first-type color material is assumed to be a monochrome black.

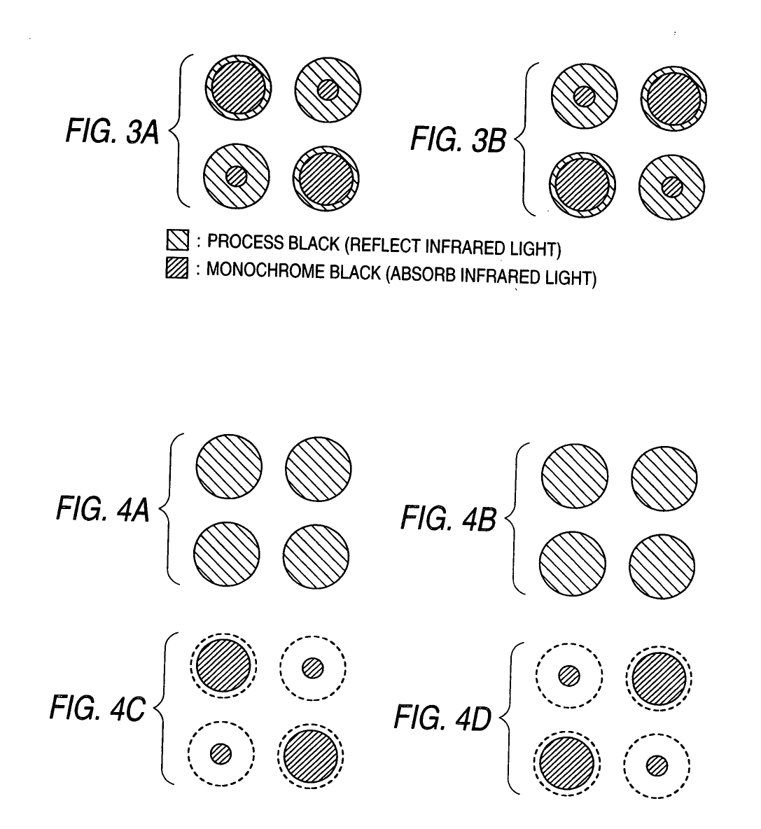

The control section 11 represents a code on the basis of locations and relative sizes of the respective graphical elements. More specifically, as shown in FIGS. 3A and 3B, the control section 11 represents a single code with use of four code image elements (in the cases of FIGS. 3A and 3B, disks (solid circles)). These four code image elements are arranged into a two by two (2×2) matrix, thereby constituting a virtual rectangular block (hereinafter referred to as a “virtual block”).

Hereinbelow, the code image elements included in each of the virtual block are referred to as first, second, third, and fourth code image elements, clockwise from the top left.

In the example of FIGS. 3A and 3B, a pattern (FIG. 3A) where radii of the disks of the first and third code image elements are relatively large (for instance, a diameter of eight pixels) and those of the second and fourth code image elements are relatively small (for instance, a diameter of four pixels) is assumed to represent a code “0.” In addition, a pattern (FIG. 3B) where radii of the disks of the second and fourth code image elements are relatively large and those of the first and third code image elements are relatively small is assumed to represent a code “1.” More specifically, the code “0” is assigned to a case where the sets of the code image elements having the relatively large radius are diagonally arrayed in the downward-right direction; and the code “1” is assigned to a case where the same are diagonally arrayed in the upward-right direction.

The control section 11 arranges a predetermined number of the virtual blocks, such as those illustrated in FIGS. 3A and 3B, in each line; in other words, arranges the blocks into an “n”×“m” matrix (“n” and “m” are integers) in accordance with codes to be embedded (i.e., permutations of “0”s and “1”s), thereby constituting a code image. Meanwhile, the code to be embedded is user data having been coded, and the code may include, for instance, predetermined error-correcting codes.

Furthermore, the control section 11 generates a command to form a modulated image from the second-type color material. The second-type color material is assumed a black (process black) obtained by means of mixing cyan, magenta, and yellow. In the embodiment, the modulated image includes four modulated image elements which respectively correspond to the code image elements. The control section 11 locates each of the modulated image elements so that at least a portion thereof overlaps the corresponding disk serving as the code image element.

More specifically, the modulated image element is assumed to be substantially concentric with the disk serving as the code image element, and to be a disk-like graphic having an outer diameter larger than that of the disk of the corresponding code image element. In other words, in the present embodiment, the disk of the code image element is located so as to be included inside the disk of the corresponding modulated image element.

More specifically, the control section 11 describes a command for drawing a disk graphic serving as the modulated image element. Subsequently, the control section 11 describes a command for drawing a disk graphic serving as the code image element in such a manner as to overwrite a portion of the disk graphic having been drawn with use of the command for drawing the disk graphic serving as the modulated image element. Accordingly, as shown in FIGS. 3A and 3B, a composite image in which the code image and the modulated image are synthesized is generated. The control section 11 outputs a command sequence for generating the composite image.

In relation to the above, the control section 11 controls graphics rendering so that the outer diameters of the respective disks included in the modulated image elements are rendered substantially uniform. When such a control is employed, irrespective of sizes of the disks of the code image elements, the code image elements and the modulated image elements are recognized to be integrated into a single element (i.e., the code image and the modulated image are recognized to be integrated into a single element) under light not falling within a predetermined wavelength range (i.e., under visible light which allows visual recognition by the human eye) where the first-type color material and the second-type color material have substantially the same reflection response. Accordingly, the diameters of all of the disks included in the virtual block are recognized to be substantially the same (FIGS. 4A and 4B). In addition, under light falling within a predetermined wavelength range where the first-type color material and the second-type color material have different reflection responses, the disks of the code image elements are recognized as having their respective sizes (FIGS. 4C and 4D). Meanwhile, for the sake of comparison, FIGS. 4C and 4D illustrate the respective disks of the modulated image elements by means of dotted lines. The portions indicated by the dotted lines are not always visible in actual images.

The control section 11 outputs to the image forming apparatus 2 a command to form the composite image. Subsequently, the image forming apparatus 2 forms the composite image from the toners of the respective colors, on a sheet of paper serving as a recording medium. Thus, an image is formed on the paper sheet serving as the recording medium, from the process black and the monochrome black having different reflection responses to the infrared light. Here, the code image, which has been generated in accordance with the data to be coded, is drawn from the monochrome black. The modulated image is drawn from the process black. When the above method is employed, the code image and the modulated image are recognized to be integrated under a light other than the infrared light (for instance, a visible light used as a light source for a general scanner). Accordingly, when the image is read under light other than the infrared light, the code image is recognized as another image different from the code image.

Next, operations of the respective sections of the infrared scanner 3 and the decoder 4 will be described. The infrared scanner 3 radiates infrared light on a paper sheet to be scanned, detects the reflected light by means of a photoelectric device, such as a CCD (charge-coupled device), converts the light into an electrical signal (image data), and outputs the electrical signal.

The control section 31 of the decoder 4 can be implemented by a CPU, or the like. The control section 31 operates in accordance with a program stored in the storage section 32. The control section 31 executes recognition processing of the code image in accordance with the image data output from the infrared scanner 3. Operations by the control section 31 will be specifically described later.

The storage section 32 is a computer-readable storage medium and includes a storage element, such as RAM (random access memory), and a hard disk device. The storage section 32 stores programs to be executed by the control section 31. The storage section 32 also serves as a working memory for the control section 31.

The operation section 33 is a mouse or a keyboard. Upon receipt of an operation command from a user, the operation section 33 outputs the corresponding contents to the control section 31. The display section 34, which is a display, or the like, displays data in accordance with a command input from the control section 31.

The communication section 35, which is an interface, such as a USB (universal serial bus), is connected to the infrared scanner 3. The communication section 35 outputs data to a designated device in accordance with the command input from the control section 31. The communication section 35 also receives data from a connected device, and outputs the data to the control section 31.

Hereinbelow, recognition processing of the code image by the control section 31 will be described. On the basis of the image data having been input, a portion where the disks including the code images are arranged is specified. Subsequently, on the array constituted of the disks, a virtual block representing each code is specified sequentially from a predetermined position (for instance, a top left corner of the array). In the embodiment, a virtual block is specified as a set constituted of a group of disks arranged in a two-by-two array.

Next, with respect to four significant pixel clusters included in the thus-specified virtual block, the control section 31 counts the number of pixels included in each of the significant pixel clusters. The “significant pixel” referred to here is a black pixel constituting the disk which is a code image element; and the “significant pixel cluster” is a continuous region of the black pixels.

The control section 31 compares a sum of the number of pixels (a first sum of the number of pixels) included in a top left significant pixel cluster and a bottom right significant pixel cluster (i.e., those at positions of the first and third code image elements), and the same (a second sum of the number of pixels) in a top right significant pixel cluster and a bottom left significant pixel cluster (i.e., those at positions of the second and fourth code image elements). When the first sum of the number of pixels is greater than the second sum of the number of pixels, the control section 31 determines that the code represented by the virtual block is “0”; and when the first sum of the number of pixels is less than the second sum of the number of pixels, the control section 31 determines that the code represented by the virtual block is “1.”

Thus, the control section 31 obtains a code represented by each of the virtual blocks specified in the array, thereby generating a code sequence. Subsequently, the control section 31 outputs the thus-generated code sequence as a result of decoding.

When the image data to be processed by the control section 31 is such data that an original (for instance, FIGS. 3A and 3B) which has been formed by the image processing apparatus 1 and the image forming apparatus 2 is read, the data include the code image corresponding to portions which absorb infrared light and appear to be black (i.e., portions formed from the monochrome black); and do not include the modulated image corresponding to portions which reflect infrared light and appear to be white (i.e., portions formed from the process black) (FIG. 4C and FIG. 4D). That is, in this case, the control section 31 performs decoding in accordance with an area of the disk graphic included in the code image element. Accordingly, data having been encoded on the image processing apparatus 1 side are to be decoded.

Meanwhile, when the original is photocopied, a scanner of a copying machine does not recognize a difference in reflectance to infrared light. Therefore, on a resultant photocopy, there is formed a disk graphic in which the code image and the modulated image are integrated by use of a monochrome toner of the copying machine. More specifically, when the resultant photocopy is scanned by use of an infrared scanner, in a case where the black toner of the copying machine reflects infrared light, the code image is invisible, and the control section 31 fails to recognize the code image. On the other hand, when the black toner of the copying machine absorbs infrared light, the respective disk graphics included in the virtual block appear to have substantially the same radii (FIG. 4A and FIG. 4B). Accordingly, determination of the codes is disabled, thereby disabling decoding.

As described above, according to the present embodiment, decoding of the photocopied code image is substantially prevented, whereby unauthorized disclosure of a code represented by the code image can be inhibited or prevented.

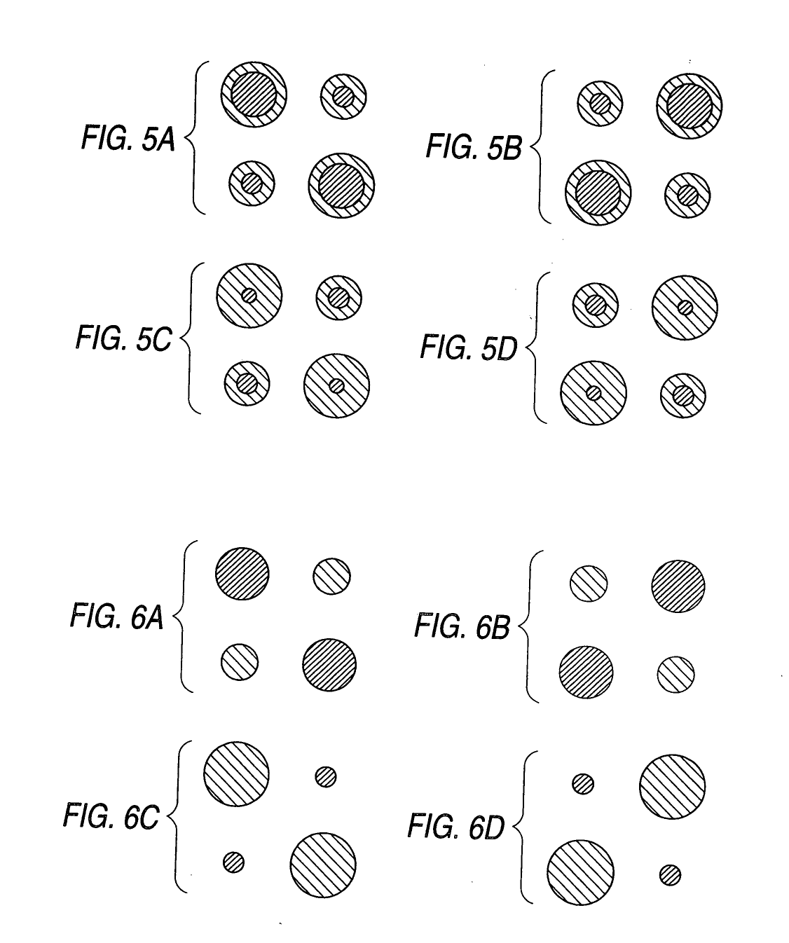

In addition, in the embodiment, outer diameters of the disk graphics in the modulated image elements have been rendered uniform. However, by means of varying the outer diameters, a two-bit code can be assigned to a 2×2 virtual block. More specifically, as shown in FIGS. 5A to 5D, three types of disks, whose radii are r1, r2, and r3 (r1>r2>r3), are designated in advance as disks of the code image elements. In addition, two types of disks, whose radii are R1 and R2 (R1>r1>R2>r2>r3), are designated in advance as disks of the modulated image elements, Subsequently, as a virtual block corresponding to a code “00,” as shown in FIG. 5A, radii of the first and third code image elements are set to r1; and radii of the corresponding modulated image elements are set to R1. In addition, radii of the second and fourth code image elements are set to r2, and radii of the corresponding modulated image elements are set to R2. Furthermore, as a virtual block corresponding to a code “11,” as shown in FIG. 5D, radii of the first and third code image elements are set to r2; and radii of the corresponding modulated image elements are set to R2. Radii of the second and fourth code image elements are set to r3, and radii of the corresponding modulated image elements are set to R1. As described above, the modulated image whose radii of elements have been changed in accordance with the code corresponds to the second code image of the invention; and the code image corresponds to the first code image.

For decoding of the code image, the infrared scanner 4 generates image data obtained by scanning with infrared light and image data obtained by scanning with visible light, and outputs the data to the decoder 3. The above can be attained when the infrared scanner 4 employs a light source which radiates light including both visible light and infrared light for scanning an original document. In addition, a result of scanning with a filter, which is opaque with respect to visible light and transparent with respect to infrared light, placed between the light source and the scanned document, or between a photo-electronic sensor and the scanned document, is assumed to be a result obtained with infrared light; and a result of scanning without the filter is assumed to be a result obtained with visible light.

The control section 31 sets a two-bit code with regard to a virtual block of interest included in the image data as follows. That is, a code obtained by means of decoding the virtual block of interest included in the image data having been scanned with infrared light is set to a higher order bit; and a code obtained by means of decoding the virtual block of interest included in the image data having been scanned with visible light is set to a lower order bit.

Also in this case, when a document produced by means of the image forming apparatus 2 is photocopied, the code image elements and the modulated image elements are integrated in the photocopied image. Therefore, when, for instance, a toner of the copying machine reflects infrared light, a result of photocopying with infrared light and that with visible light are identical images. More specifically, the higher order bit and the lower order bit are recognized to be the same in all cases, whereby only either “11” or “00” is represented.

That is, since contents of the codes are lost through photocopying, decoding of the photocopied code image is substantially prevented, and unauthorized disclosure of a code represented by the code image can be inhibited or prevented.

Furthermore, in the present embodiment, a code is represented on the basis of relative size differences between radii (differences in the number of pixels included in a pixel clusters) of disks serving as the code image elements or the modulated image elements. Accordingly, by means of varying absolute sizes of the disks, gray-scaling can be expressed, thereby enabling expression of a gray-scale image. That is, a composite image of the present embodiment can be embedded in a gray-scale image.

Specifically, the control section 11 of the image processing apparatus 1 divides image data to be expressed in gradient into a size of a virtual block (of, for instance, 16×16 pixels). Thereafter, a virtual block is selected in accordance with a predetermined order (for instance, in accordance with an order of a so-called scanning line which runs from left to right in one line, and subsequently moves to the line directly below) from a predetermined position (for instance, a top left corner of the image data) in the thus-divided virtual blocks. A two-bit code of a code sequence—which is a source of the code image—is sequentially assigned to each of the selected virtual blocks.

The control section 11 further divides each of the virtual blocks into equal 2×2 sub-blocks. Subsequently, the control section 11 modulates a gray-scale value of a pixel included in each sub-block (of 8×8 pixels size) in accordance with a value of the higher order bit of the two-bit code assigned thereto. More specifically, when “0” is assigned to the code, gray-scale values of the pixels within top left and bottom right sub-blocks are caused to increase only by a predetermined value. In addition, gray-scale values of the pixels within bottom left and top right sub-blocks are caused to decrease only by a predetermined value. When “1” is assigned to the code, gray-scale values of the pixels within top left and bottom right sub-blocks are caused to decrease only by a predetermined value; and gray-scale values of the pixels within bottom left and top right sub-blocks are caused to increase only by a predetermined value.

Furthermore, the control section 11 determines a color material forming pixels included in each sub-block in accordance with a value of the lower order bit of the two-bit code assigned thereto. More specifically, when “0” is assigned to the code, the top left and bottom right pixels in the sub-block are set so as to be expressed by the monochrome black; and the bottom left and top right pixels in the sub-block are set so as to be expressed by the process black. In addition, when “1” is assigned to the code, the top left and bottom right pixels in the sub-block are set so as to be expressed by the process black; and the bottom left and top right pixels in the sub-block are set so as to be expressed by the monochrome black.

The control section 11 subjects the thus-set image to dithering processing. The dithering processing is effected such that a dither matrix is caused to be of the same size as the sub-block so that the dither matrix overlaps the sub-block, and that gray-scale dots grow from a center of the sub-matrix. As a result, code images as shown in FIGS. 6A to 6D are generated for two-bit codes of “00,” “11,” “10,” and “01,” respectively. The images shown in FIGS. 5A to 6D indicate code images which represent two bits by use of a single block; however, when a code of greater than two bits is encoded, there is generated a code image in which a plurality of code images as shown in FIGS. 6A to 6D are arrayed vertically, horizontally. The image forming apparatus 2 forms an image of the thus-generated code image.

In this case, for decoding the code image, the infrared scanner 4 generates image data obtained by scanning with infrared light and image data obtained by scanning with visible light, and outputs the image data to the decoder 3. With regard to a virtual block of interest included in the image data, a code obtained by means of decoding the virtual block of interest in the image data scanned with infrared light is set to a higher order bit; and a code obtained by means of decoding the virtual block of interest in image data scanned with visible light is set to a lower order bit. Meanwhile, in the embodiment, the image data having been scanned with infrared light are not decoded in accordance with a size of a pixel block included in the virtual block of interest, but are decoded in accordance with a position where the pixel block is located. More specifically, a virtual block where the pixel clusters are present at positions corresponding to the top left and bottom right sub-blocks and absent at positions corresponding to the bottom left and top right sub-blocks is decoded into “0,” and a virtual block where the pixel blocks are present at positions corresponding to the bottom left and top right sub-blocks and absent at positions corresponding to the top left and bottom right sub-blocks is decoded into “1.”

In this case, photocopying of a subject document having been formed by the image forming apparatus 2 results in data loss corresponding to the lower order bit. Accordingly, decoding of the photocopied code image is substantially prevented, and unauthorized disclosure of a code represented by the code image can be inhibited or prevented.

The system of the present embodiment is configured as described above. Therefore, for instance, when a ticket is printed by means of the image processing apparatus 1 and the image forming apparatus 2, the following is conceivable. That is, code images formed from the process black, and modulated images formed from the monochrome black are formed on the surface of the ticket. Thereupon, the authenticity of the ticket can be determined by means of determining whether or not both the code image and the modulated image can be recognized when the ticket is read under infrared light.

In addition, there may also be possible that one of virtual blocks shown in FIGS. 5A to 5D is formed on a sheet of paper in advance and that, in accordance with the virtual block, a copying machine may control whether or not the sheet of paper can be photocopied. In each of the virtual blocks shown in FIGS. 5A to 5D, a code corresponding to two bits is represented, and data of the higher order bit is lost through photocopying. Hence, the codes are set as follows: when the code is “00,” photocopying is prohibited; when the code is “10,” only one photocopy is allowed; and when the code is “11,” photocopying is allowed without restriction.

The copying machine decodes a code represented by the virtual block in the image of the subject document to be photocopied, and calculates an OR result of the higher order bit and the lower order bit of the thus-decoded code. When the OR result is “1,” the copying machine determines that photocopying is allowed, and performs the photocopies the original document. When the OR result is “0,” the copying machine determines that photocopying is not allowed, and stops the photocopying of the original document.

When the above configuration is employed, in a case where an original document which includes a code indicating “10” is photocopied, the code image elements and the modulated image elements are integrated, whereby the higher order bit and the lower order bit have the same information. Accordingly, “10” is read as having been changed to “00,” thereby restricting reproduction to first-generation copies.

Alternatively, such a configuration that a content of data represented by a code image formed by the image forming apparatus 2 is changed when the image is subjected to photocopying by a copying machine is also possible. In this case, data of one bit is encoded into a two-bit code in accordance with the following encoding rule, and the two-bit code is generated into a one-block code image shown in FIGS. 5A to 5D:
“01” information bit (which changes into “0” bit after photocopying)→“00” (FIG. 5A);
“0” information bit (which changes into “1” bit after photocopying)→“11” (FIG. 5D);
“1” information bit (which changes into “0” bit after photocopying) “01” (FIG. 5C); and
“1” information bit (which changes into “1” bit after photocopying)→“10” (FIG. 5B).

More specifically, “0” information bit is encoded into either a “00” or “11” code whose higher order bit and lower order bit have the same value; and “a 1” information bit is encoded into either a “01” or “10” code whose higher order bit and lower order bit have different values. Determination with regard to which one of the two codes the code is to be encoded into is performed on the basis that a code whose higher order bit value is the same as a desired bit value after photocopying.

When the code is decoded, a higher order bit of the two-bit code is extracted, to thus obtain a decoded bit. More specifically, each of “00” and “01” is decoded as a “0” bit, and each of “10” and “11” is decoded as a “1” bit.

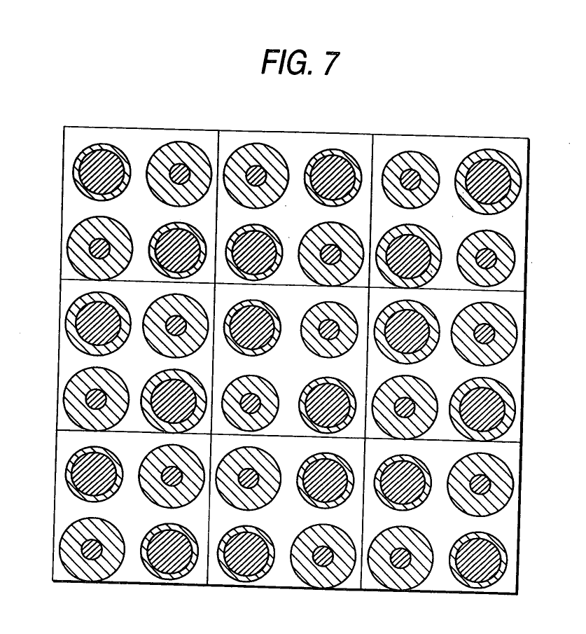

For instance, in a case where nine bits of information consisting of “110010110” before photocopying is changed into “101010101” after photocopying, when encoding in accordance with the above encoding rule is effected, “10,” “01,” “11,” “00,” “10,” “00,” “10,” “01,” and “10” are obtained. FIG. 7 shows a code image generated in accordance with the codes. An image is formed on the basis of the code image. When the image is photocopied by means of a copying machine, disks formed from the process black are photocopied as the monochrome black. Accordingly, the code “01” changes into “00,” and the code “10” changes into “11.” “00” and “11” remain unchanged. Therefore, the codes “10,” “01,” “11,” “00,” “10,” “01,” and “10” change into “11,” “00,” “11,” “00,” “11,” “00,” “11,” “00,” and “11.” When the photocopied codes are decoded, “10101010101” is obtained.

Meanwhile, the foregoing description has been provided in relation to examples where four pixel clusters represent a one-bit to two-bit code; however, the invention is not limited thereto.

In addition, in the above description, the process black has been employed as the second-type color material. However, the second-type color material may be a color in which color materials, such as cyan, magenta, and yellow, which reflect infrared light are arbitrarily combined. Furthermore, the code image element and/or modulated image element is not necessarily of a disk-shape, and may be rectangular. Hithertofore, an embodiment where the code image element is enclosed inside the modulated image element has been provided. However, the invention is not limited thereto, so long as a portion of the code image element overlaps a portion of the modulated image element and both are recognized as being integrated in a photocopied image.

According to the embodiment, unauthorized disclosure of a code represented by a code image can be inhibited or prevented.

As described above, some embodiments of the invention are outlined below.

An image processing apparatus which utilizes a first-type color material and a second-type color material which differ in reflection response to light falling within a predetermined wavelength range, the image processing apparatus includes a controller that generates a code image in accordance with data to be coded with use of the first-type color material, generates a modulated image with use of the second color material and combines the code image and the modulated image to generate a combined image.

In the embodiment of this invention, the combined image is recognized as different image from the code image under a light falling outside of the predetermined wavelength range.

In the embodiment of this invention, a code represented by a photocopy of the combined image data is recognized as a different code from a code represented by the code image

In the embodiment of this invention, the controller may generate the code image from the first-type color material by means of a plurality of sets of graphical elements; and the code image may represent a code on the basis of locations and relative size differences among the respective graphical elements included in the plurality of sets of the graphical elements.

In the embodiment of this invention, at least a portion of the modulated image may be located so as to overlap the graphic element, and a relative size of the code image is ascertained to be substantially identical with that of an image including the code image and the modulated image adjacent thereto under light falling outside the predetermined wavelength range.

In the embodiment of this invention, at least a portion of the modulated image may be located so as to overlap the graphic element, and a relative size of the code image is different from that of an image including the code image and the modulated image adjacent thereto under light falling outside the predetermined wavelength range.

In the embodiment of this invention, the controller may further controls sizes of the graphic elements, and the graphic elements expresses a gray-scale image.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

The entire disclosure of Japanese Patent Application No. 2004-270580 filed on Sept. 16, 2004 including specification, claims, drawings and abstract is incorporated herein by reference in its entirety.

What is claimed is:

1. An image processing apparatus which utilizes a first-type color material and a second-type color material which differ in reflection response to light falling within a predetermined wavelength range, the image processing apparatus comprising:
a controller that:
generates a code image in accordance with data to be coded with use of the first-type color material;
generates a modulated image with use of the second color material; and
combines the code image and the modulated image to generate a combined image, wherein
the combined image is recognized as different image from the code image under a light falling outside of the predetermined wavelength range.

2. The image processing apparatus according to claim 1, wherein
the controller generates the code image from the first-type color material by means of a plurality of sets of graphical elements; and
the code image represents a code on the basis of locations and relative size differences among the respective graphical elements included in the plurality of sets of the graphical elements.

3. The image processing apparatus according to claim 2, wherein at least a portion of the modulated image is located so as to overlap the graphic element, and a relative size of the code image is ascertained to be substantially identical with that of an image including the code image and the modulated image adjacent thereto under light falling outside the predetermined wavelength range.

4. The image processing apparatus according to claim 2, wherein at least a portion of the modulated image is located so as to overlap the graphic element, and a relative size of the code image is different from that of an image including the code image and the modulated image adjacent thereto under light falling outside the predetermined wavelength range.

5. The image processing apparatus according to claim 1, wherein the controller controls sizes of the graphic elements, and the graphic elements expresses a gray-scale image.

6. An image processing apparatus which utilizes a first-type color material and a second-type color material which differ in reflection response to light falling within a predetermined wavelength range, the image processing apparatus comprising:
a controller that:
divides data to be encoded into a first portion and a second portion;
generates a first code image in accordance with the first portion of the data to be coded from the first-type color material;
generates a second code image in accordance with the second portion of the data to be coded from the second-type color material; and
generates image data including the first code image and the second code image.

7. An image processing apparatus which utilizes a first-type color material and a second-type color material which differ in reflection response to light falling within a predetermined wavelength range, the image processing apparatus comprising:
a controller that:
generates a code image in accordance with data to be coded with use of the first-type color material,
generates a modulated image with use of the second color material, and
combines the code image and the modulated image to generate a combined image, wherein
a code represented by a photocopy of the combined image data is recognized as a different code from a code represented by the code image.

8. A decoder for reading a code image formed on a recording medium,
the recording medium including:
a code image generated in accordance with data to be coded with use of a first-type color material, and
a modulated image generated with use of a second color material, wherein
the first-type color material and the second-type color material differ in reflection response to light falling within a predetermined wavelength range, and
the code image is processed to be ascertained as an image differing from the code image, under a light falling outside of the predetermined wavelength range, by combining the modulated image,
the decoder comprising:
a reading unit which reads the image formed on the recording medium under light falling within the predetermined wavelength range;
a generating unit which generates image data in accordance with the read image; and
a decoder that decodes the generated image in a predetermined decoding process.

9. A decoder for reading a code image formed on a recording medium,
the recording medium including:
a first code image generated from a first-type color material in accordance with a predetermined portion of data to be coded; and
a second code image generated from a second-type color material in accordance with a portion other than the predetermined portion of the data to be coded, wherein
the first-type color material and the second-type color material differ in reflection response to light falling within a predetermined wavelength range, the decoder comprising:
a reading unit which reads the image formed on the recording medium under light falling within the predetermined wavelength range, and an image formed on the recording under light falling outside the predetermined wavelength range; and
a generating unit which generates two sets of image data in accordance with the respective images obtained by reading; and
a decoder that decodes the generated two set of image in a predetermined decoding process.

10. An image processing method which utilizes a first-type color material and a second-type color material which differ in reflection response to light falling within a predetermined wavelength range,
the image processing method comprising:
generating a code image from the first-type color material in accordance with data to be coded;
generating a modulated image from the second color material;
combining the code image and the modulated image to generate a combined image, wherein
the combined image is recognized as different image from the code image under a light falling outside of the predetermined wavelength range.
